(19) United States
(12) Patent Application Publication
(10) Pub. No.: US 2024/0386477 A1
(43) Pub. Date: Nov. 21, 2024

(54) METHODS AND SYSTEMS FOR PROVIDING CONTEXT FOR GENERATING AN ONLINE STORE

(71) Applicant: Shopify Inc., Ottawa (CA)

(72) Inventors: Christopher Johnston, Pickering (CA); Marie-Philipe Boucher, Verdun (CA); Irina Tosic, Mississauga (CA); Donn Pasiliao, Toronto (CA); Rafal Nedzarek, Holland (NL)

(21) Appl. No.: 18/353,212

(22) Filed: Jul. 17, 2023

Related U.S. Application Data
(60) Provisional application No. 63/502,490, filed on May 16, 2023.

(51) Int. Cl. G06Q 30/0601

(52) U.S. Cl. CPC G06Q 30/0641

(57) ABSTRACT

A computer method including fetching, from a first address, first domain content; analysing the first domain content to determine character information and content information; selecting a template from amongst a plurality of templates associated with a Software-as-a-Service (SaaS) application based on at least one of the character information and the content information; and configuring the SaaS application based on the character information and content information using the selected template.

### RELATED APPLICATIONS

The present disclosure claims the benefit of U.S. Provisional Application No. 63/502,490 entitled “METHODS AND SYSTEMS FOR PROVIDING CONTEXT FOR GENERATING AN ONLINE STORE”, filed May 16, 2023, the contents of which are incorporated herein by reference in their entirety.

### FIELD OF THE DISCLOSURE

The present disclosure is related to the creation of a domain, and in some cases relates to creation of a domain for an electronic commerce storefront.

### BACKGROUND

Software as a Service is a network or cloud based software licensing and delivery model, hosted by a third-party provider, which allows subscribers to access software applications over a network such as the Internet. One example of a third party provider is an ecommerce platform, which facilitates management of websites, for example through a domain hosting service, along with marketing, sales and operations for electronic storefronts.

Occasionally an electronic storefront or similar domain may wish to switch to a new domain hosting service.

### SUMMARY

In the embodiments of the present disclosure, methods and systems are provided to facilitate the migration from a first domain to a second domain. The second domain may, in some cases, be an electronic storefront. However, while the examples below illustrate the second domain as an electronic storefront, this is merely provided for illustration and the second domain could be any domain including blog posts, social media posts, websites, among other options.

The migration to the second domain may involve generating a preview utilizing at least one of the look and feel and the contents from the first domain without having a user sign up for the second domain. Further, in some cases, the preview may use a theme or template selected from a plurality of such themes or templates at the second domain, where the theme or template is selected based on information from the first domain.

In some cases, the preview then can be used to complete the migration from the first domain to the second domain.

Therefore, in one aspect, a method at a computing system is provided. The method may include fetching, from a first address, first domain content and analysing the first domain content to determine character information and content information. The method may further include selecting a template from amongst a plurality of templates associated with a Software-as-a-Service (SaaS) application based on at least one of the character information and the content information and configuring the SaaS application based on the character information and content information using the selected template.

In some embodiments, the selected template may be a closest match to the content information amongst the plurality of templates.

In some embodiments, configuring the SaaS application based on the character information and content information using the selected template may include generating a website based on the selected template using the character information and content information.

In some embodiments, selecting the template may utilize a Large Language Model (LLM).

In some embodiments, the generating may be performed by providing the template, content information and character information to a Large Language Model.

In some embodiments, the analysing may comprise using the first content with a Large Language Model to determine the character information and content information from the first domain content.

In some embodiments, the method may further comprise providing a preview of the website.

In some embodiments, the first address may be a uniform resource locator for a first domain, and the first domain content may comprise at least one of an electronic storefront, a blog, a landing screen, and a website.

In some embodiments, the character information may include at least one of a colour scheme, fonts, and a tone of text.

In another aspect, the present disclosure may provide a computer system having a processor and a communications subsystem. The computer system may be configured to fetch, from a first address, first domain content and analyse the first domain content to determine character information and content information. The computer system may further be configured to select a template from amongst a plurality of templates associated with a Software-as-a-Service (SaaS) application based on at least one of the character information and the content information and configure the SaaS application based on the character information and content information using the selected template.

In some embodiments, the selected template may be a closest match to the content information amongst the plurality of templates.

In some embodiments, the SaaS application may be configured based on the character information and content information using the selected template by generating a website based on the selected template using the character information and content information.

In some embodiments, the computer system may be configured to select the template utilizing a Large Language Model (LLM).

In some embodiments, the computer system may be configured to generate by providing the template, content information and character information to a Large Language Model.

In some embodiments, the computer system may be configured to analyse by using the first content with a Large Language Model to determine the character information and content information from the first domain content.

In some embodiments, the computer system may further be configured to provide a preview of the website.

In some embodiments the first address may be a uniform resource locator for a first domain, and the first domain content may comprise at least one of an electronic storefront, a blog, a landing screen, and a website.

In some embodiments, the character information may include at least one of a colour scheme, fonts, and a tone of text.

In another aspect, a non-transitory computer readable medium for storing instruction code may be provided. The instruction code, when executed by a processor within a computer system, may cause the computer system to fetch, from a first address, first domain content and analyse the first domain content to determine character information and content information. The instruction code, when executed by a processor within a computer system, may further cause the computer system to select a template from amongst a plurality of templates associated with a Software-as-a-Service (SaaS) application based on at least one of the character information and the content information and configure the SaaS application based on the character information and content information using the selected template.

In some embodiments, the selected template may be a closest match to the content information amongst the plurality of templates.

### BRIEF DESCRIPTION OF THE DRAWINGS

The present disclosure will be better understood with reference to the drawings, in which:

FIG. 1A is a block diagram of a simplified convolutional neural network, which may be used in examples of the present disclosure.

FIG. 1B is a block diagram of a simplified transformer neural network, which may be used in examples of the present disclosure.

FIG. 2 is a block diagram of an example computing system, which may be used to implement examples of the present disclosure.

FIG. 3 is a block diagram showing an example e-commerce system capable of implementing the embodiments of the present disclosure.

FIG. 4 is a block diagram showing an example interface for a merchant using the e-commerce platform of FIG. 3.

FIG. 5 is a process diagram showing an example process for generating a preview for a second domain from information from a first domain.

FIG. 6 is a block diagram showing an example preview for a second domain using information from a first domain.

FIG. 7 is a block diagram showing a further example preview for a second domain using information from a first domain.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In accordance with various embodiments of the present disclosure, information from a first domain can be matched with a template and used to generate a second domain.

In particular, a user may wish to switch to a new domain hosting service for various reasons, including pricing, features, and services offered. However, one challenge that such user may face includes previewing how their brand media, copy and other content will appear on the new domain without having to manually create an account, import brand media and text, and make various adjustments to fit the new purpose of the web page.

Additionally, in some cases, the user must navigate through a fixed onboarding path before being able to view contextual pages that such user is interested in previewing. Examples of previews a user may be interested in may include a checkout page or product display containing a user's products.

In this regard, one challenge is providing an interface that allows users to preview their brand media and copy on a new domain without any manual importation or registration process. This system may further take into account the fact that the new web page may require certain modifications to fit a distinct purpose. For instance, a user may be moving from a landing page or blog to an online store, which may require changes to the text or images. However, the user may still wish to keep some elements of the first web page, such as color scheme, font or tone of text, among other examples.

Based on this, the embodiments of the present disclosure provide methods and systems which allow users to preview their migrated content on a new domain, and in some cases to create the layout for a site, on the second domain. This may be accomplished by allowing input of information concerning current domains that a user may have. For example, the input of information may include the input of a uniform resource locator (URL) or other address associated with a user's first domain, screen grabs of the user's first domain, images, among other information. If the information includes an address, a system service may fetch contents from the first domain including screenshots, images, text and other media.

Character information from the first domain may then be derived. As used herein, character information is information about the “look and feel” of the first domain, and may include colour schemes, fonts, tone of text, among other information.

In one case, character information may be derived using a Large Language Model (LLM) analyzing the HTML of the website, for example using an LLM such as ChatGPT. In other cases, the images, screen captures or other contents that have been fetched may be analyzed using other artificial intelligence models such as GPT-4. However, in some cases the information may be processed without using artificial intelligence, and the present embodiments are not limited to artificial intelligence models such as LLMs.

Further, other information may be derived from the fetched contents. This may include “content information” about products being sold, the type of products or services being offered, and/or logos or other artwork, among similar information.

In some cases, a user interface may allow a user to select retrieved content from the first domain and provide instructions on how the media should be incorporated into the second domain.

In some cases, a template (or theme) for the second domain may be selected.

In some cases, the template for the second domain may be derived based on information from the first domain. For example, the service may analyze the content of the first domain and determine a structure, such as the use of multiple columns or the placement of multimedia elements. The system could then compare this structure to a database of available templates to find one that is similar to the structure of the first domain. Additionally, the system may analyze the colour scheme of the first domain to identify the primary and secondary colors in use. In some cases, the system could then search for theme templates that uses similar color palette or that have color schemes that compliment the colors of the first domain. In other cases, the templates may be modified to use the color scheme of the first domain. Other options are possible.

The check for whether the chosen template is similar to the structure of the first domain may use a distance metric which may be based on one or more factors, and may be weighted, linear or some combination to determine the template most similar to the structure of the first domain.

In some cases, the user could request to view the second domain with a different template.

Based on the information derived from the first domain, as well as template information for the second domain, a layout may be derived for the second domain. Such layout may be derived in some cases using an LLM. In some cases, layout may be derived using a template with information input into fields based on the derived information. Other options are possible.

In some cases, this preview may be modified or reconfigured based on input from a user. For example, this may be based on instructions from a user, and could include, in some cases, a selection of a new template.

The preview may include a complete website, such as a mock-up of a complete storefront, where links and buttons may function as in a live version in some cases. In other cases, a subset of subdomains (or webpages within a website) may be created, such as a help page, an about us page, a checkout page, among other options.

Once the user is satisfied, a storefront may be created based on the preview. In this case, the user may need to provide certain information to complete the creation of the second domain (however, in some cases the second domain may be a storefront and have potentially the same URL as the first domain, but hosted by a different provider, for example—thus while the term “second domain” is used herein, in some cases it may have the same location as the first domain). However, the information derived from the first domain can be used to create a look and feel for the second domain, and may in some cases create placeholders for products or services in such second domain. This migration, for example, may be accomplished with a single click.

The storefront may be populated with applications based on a region of the user, types of products being sold, among other options. The country or region may also change shipping options, languages, among other differences for the preview and/or new domain.

The embodiments of the present disclosure therefore provide a user experience system for providing content from a first domain as input to a service for generating an online store. In some cases, the domain may be a storefront, and the creation and obtaining of information may use a large language model. In this regard, each are described below.

### Machine Learning and Computing Device

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

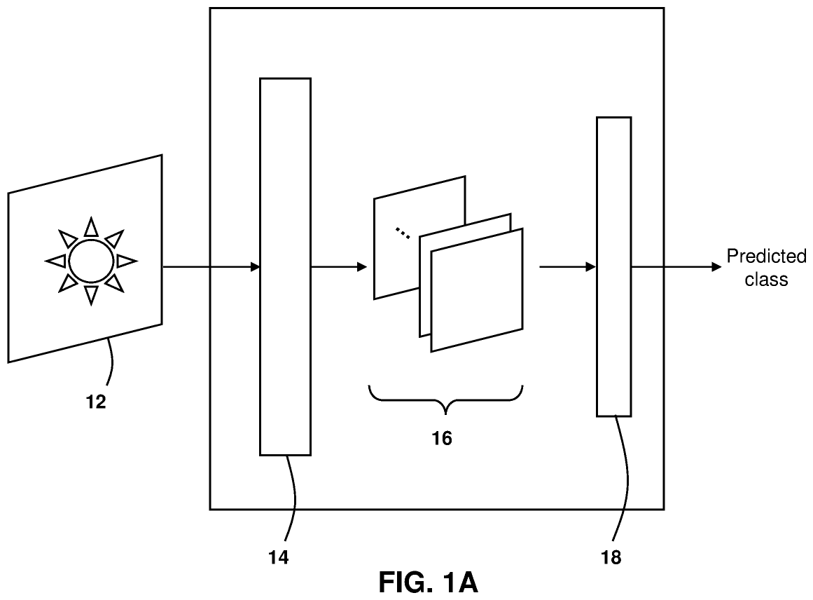

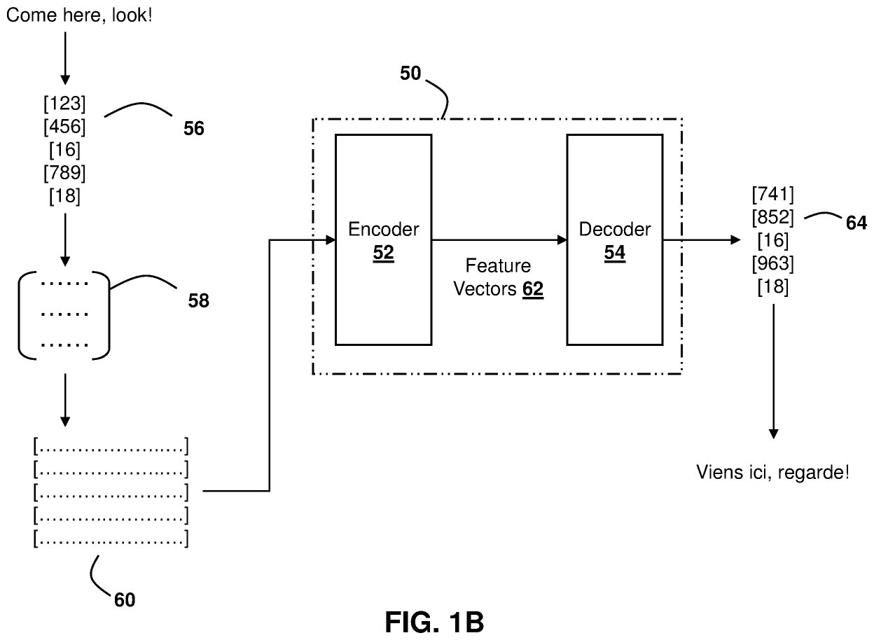

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

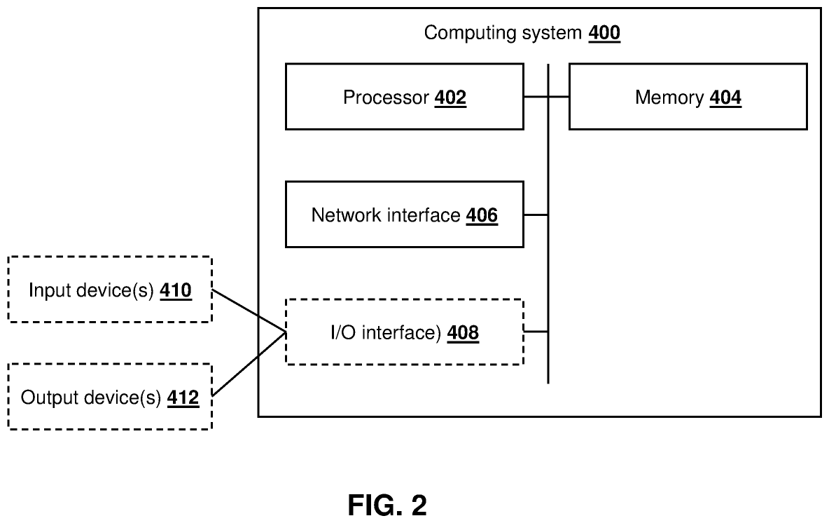

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

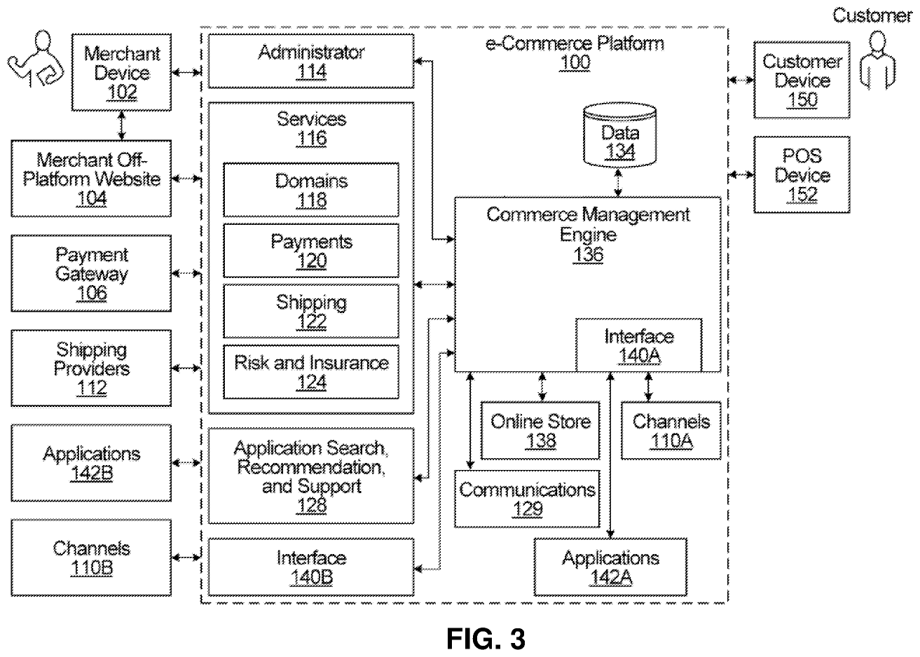

FIG. 3 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 3, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc., In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

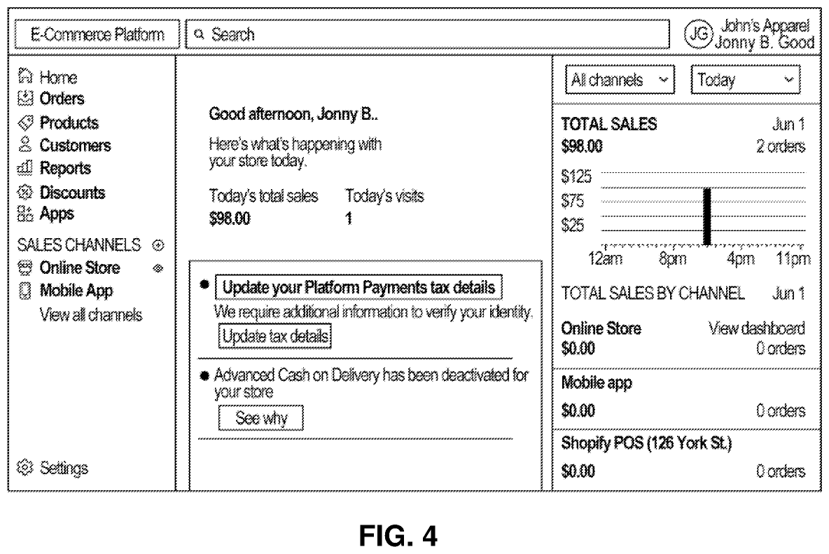

FIG. 4 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 4. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 3, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Preview and Website Generation

As outlined above, a user may wish to transfer domains or transfer their services to a new domain provider. For example, a user may currently own a first domain, which may comprise a blog, website, storefront, multimedia account, among others, and for various reasons may wish to transfer to another domain provider. However, the user may be reluctant to transfer to a second domain as they may be unsure how their website or web pages will look on the second domain.

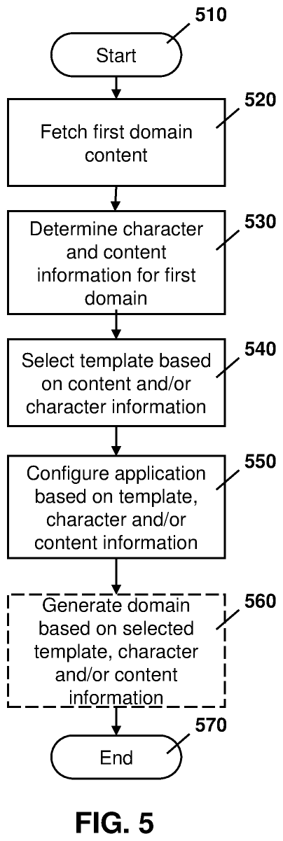

In this regard, reference is now made to FIG. 5, which shows a process for configuring a preview, and/or generating the second domain.

In particular, the process of FIG. 5 starts at block 510 and proceeds to block 520 in which a computer system may fetch first domain content. For example, the user may provide a uniform resource locator (URL) or similar address for the first domain. In some cases, the user may upload screen captures, images, multimedia, text, videos or similar content to replace or supplement the information provided through a URL.

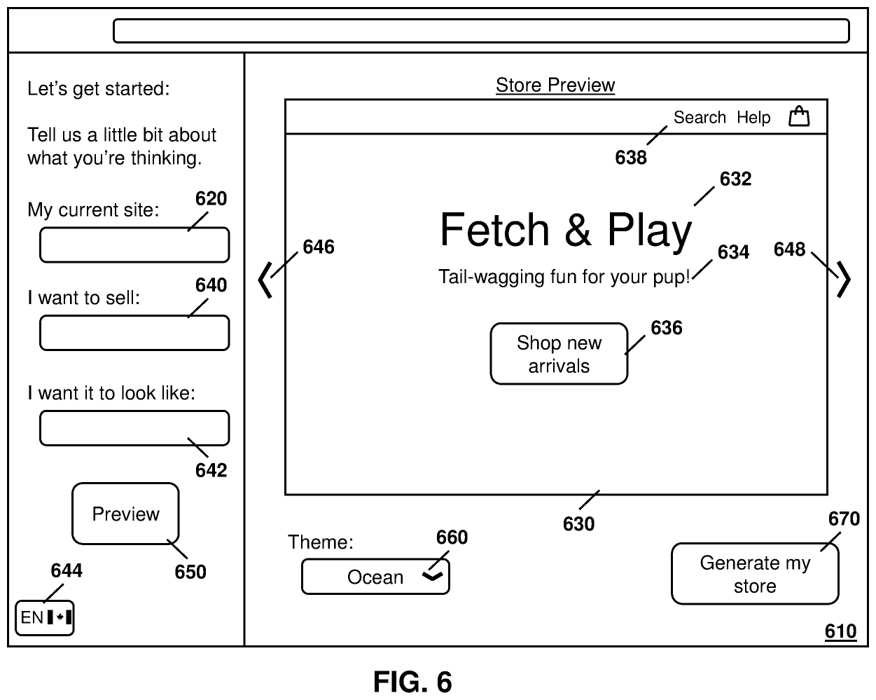

For example, referring to FIG. 6, a domain preview page 610 may be provided to a user. The domain preview page 610 in the example FIG. 6 is merely one option for a domain preview page and is provided for illustration.

On the domain preview page 610, an input field 620 allows a user to enter the address or URL of the user's current domain or website. Similar input fields could exist for uploading documents, images, videos, or other multimedia or files.

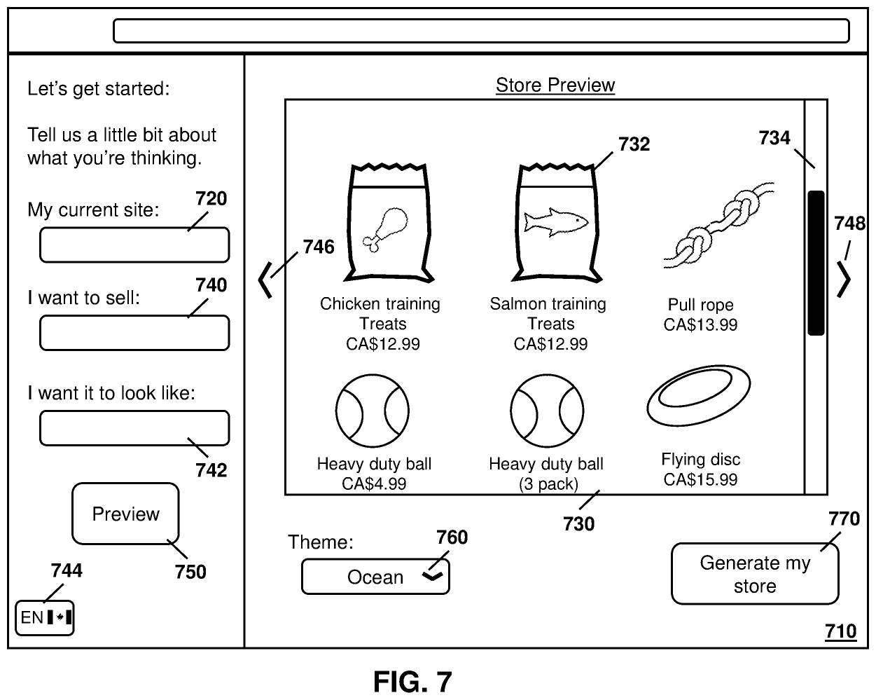

Similarly, referring to FIG. 7, a further domain preview page 710 may be provided to a user. The domain preview page 710 in the example FIG. 7 is again merely one example.

On the domain preview page 710, an input field 720 allows a user to enter the address or URL of the user's current domain or website. Similar input fields could exist for uploading documents, images, videos, or other multimedia or files.

Referring again to FIG. 5, from block 520, the process proceeds to block 530 in which character and content information for the first domain may be determined. As indicated previously, the character information in the first domain refers to the look and feel of the first domain, and may include features such as the font utilized in the first domain, the tone of the text, the colour scheme, background images or wallpapers, among other aspects. The content information deals with the actual content of the first domain, and may include items such as products being sold, types of products or services being offered or discussed, logos or artwork found in the domain, among other such information.

The determining at block 530 may be done at a computing system used for the preview generation. For example, the computing system may fetch the first domain content and utilizing various algorithms may determine dominant fonts, color schemes such as a primary or background color, secondary colors, among other options. For example, such algorithm may analyze the font on the first domain and determine which font occurs most frequently to find the dominant font. Similarly, the algorithm may analyze the background color and find which colors are used the most on the first domain. Other options are possible.

In some cases, the first domain content may be provided to a secondary computer system that may perform the analysis. For example, such secondary computer system may include a large language model or other artificial intelligence engine that could perform the analysis and provide information with regard to the character of the first domain.

Similarly, the first domain may be analyzed for content information. This may again occur on the computing device that is performing the preview or on a remote computing device. The analysis may use a large language model to determine the focus of the first domain, including the field being discussed, the items being sold, among other information.

In some cases, the analysis may be facilitated by the nature of the first domain. For example, if the first domain is a storefront and the second domain is a storefront, then the analysis is simplified since the products being sold on the first domain are likely going to be sold on the second domain.

However, in some cases, the first domain may differ from the second domain, in which case more detailed analysis may need to occur. For example, if the first domain is a blog and the second domain is a storefront, then the nature of the blog may need to be analyzed to determine whether the user is discussing certain topics or whether certain products may tie into the blog, for example.

Therefore, in some cases, the analysis may occur on the computing device itself, whereas in other cases information may be sent to a secondary computing device to perform further analysis.

Once the character information and/or content information for the first domain is determined at block 530, the process proceeds to block 540 in which a template or theme may be selected based on the content and/or character information that was determined at block 530.

As used herein, a template or theme may be part of a Software as a Service (SaaS) platform that allows users to easily create websites and web pages on the SaaS domain. For example, the template or theme may include blocks which define where headers go, where products go, layouts for help and checkout pages, the type of applications that can be used with the domain, color schemes, and/or font schemes, navigation, among other features.

Such SaaS platform may include a plurality of templates or themes that a user typically would be allowed to select when signing up for the services of the platform. For example, in the embodiment of FIG. 6, a preview screen 630 may utilize a first template which includes the landing page for the domain. This may include a title 632 which may be a particular font, size and located in a particular area of the landing page. Similarly, a tagline or trademark 634 may be displayed underneath the title, wherein the tagline or trademark 634 is provided in a different font size and may be a different font than the title 632. Buttons or inputs 636 and menus 638 may be further provided as part of the theme or template.

In some cases, the theme or template may include background colors, font selections, among others. In other cases, such background colors, text colors, font selections may be customizable.

Similarly, in the embodiment of FIG. 7, the preview screen 730 may use a template in which products 732 are being sold, where the products are laid out in three columns with a scrollbar 734 allowing the user to scroll through the product. Products 732 are further configured to show a product picture, a brief product title, and a price in a stacked configuration.

The template or theme used in the examples of the FIG. 6 and FIG. 7 may be the same and may merely represent a landing screen and a product page within the template.

In other cases, the two figures may be part of different themes or templates.

In the embodiment of FIG. 5, at block 540, a template may be selected based on the content and/or the character information determined at block 530. For example, the service may analyze the first domain and determine a structure, such as the use of multiple columns or the placement of multimedia elements. The system could then compare this structure to a database of available templates to find one that is similar to the structure of the first domain. Additionally, the system may analyze the color scheme of the first domain to identify the primary and secondary colors in use. In some cases, the system could then search for templates that use a similar color palette or that have color schemes that compliment the colors of the first domain. In other cases, the templates may be modified to use the color scheme of the first domain. Other options are possible.

Therefore, at block 540, a template may be checked to determine whether it is similar to the structure of the first domain, and such check may use a distance metric which may be based on one or more factors, and may be weighted, linear or some combination. This may occur for all available templates in some cases, or for a subset of templates in some cases, to determine the template most similar to the structure of the first domain.

In some cases, prior to generating a preview, other information may be provided. For example, in the embodiment of FIG. 6, an input field 640 may indicate the types of products or services that the user wishes to sell. Input field 642 may indicate constraints or preferences for how the preview will look. Input field 644 may indicate the target language and country that the user wishes to generate the preview for. Such input fields are merely provided for illustration though, and those skilled in the art will appreciate that other input fields could equally be used with the embodiments of the present disclosure.

Similarly, in the embodiment of FIG. 7, an input field 740 may indicate the types of products or services that the user wishes to sell. Input field 742 may indicate constraints or preferences for how the preview will look. Input field 744 may indicate the target language and country that the user wishes to generate the preview for. Again, such input fields are merely provided for illustrative purposes.

Referring again to FIG. 5, based on the information derived from the first domain, as well as template information for the second domain, and potentially other inputs, a layout may be derived for the second domain at block 550. Such layout may be configured in some cases using an LLM. In some cases, layout may be derived using a template with information input into fields based on the derived information. Other options are possible.

For example, on pressing preview button 650 from FIG. 6, or preview button 750 from FIG. 7, a preview may be generated by providing a prompt to an LLM, where the prompt may, for example, ask the LLM to “create a web page using a color palette [palette] and a template [template] for selling [products]”.

As will be appreciated by those in the art, the actual prompt provided to the LLM may be different or more specialized depending on the type of information that is available for the preview, including additional input fields, language and country, additional display instructions, among others.

Further, in some cases, the LLM may be queried for specific aspects or inputs, which, when returned by the LLM, are then plugged into the template, rather than having the LLM generate the preview entirely.

In some cases, the preview generated at block 550 can function as a working website. Specifically, navigation on the website can be provided through links and buttons that may function as if the web page was live. This may allow user to get a good feel for what the website will look like and how it will function if the user decides to proceed to move to the second domain.

Additionally or alternatively, buttons 646 and 648 from the embodiment of FIG. 6, or buttons 746 and 748 from the embodiment of FIG. 7, could be pushed to preview another page on the website in some cases.

In some cases, the preview may include items found online or on an network. For example, if the first domain discusses printers or if the input to fields 640 or 740 indicate that the user wants to sell printers, but the user has no printers on their first domain, then the preview may be populated with printers that are found on the Internet in a format that is consistent with the template.

The preview may include a complete website, such as a mock-up of a complete storefront, where links and buttons may function as in a live version in some cases. In other cases, a subset of subdomains (or webpages within a website) may be created, such as a help page, an about us page, a checkout page, among other options.

Further, the preview can be modified by the user by changing various aspects of the information provided at block 550. For example, if the user chooses to select a different language or country with input field 644 or 744, this may allow the preview to be updated. As will be appreciated by those in the art, the changing at the input field 644 or 744 may trigger the update, and a user may not need to press a preview button 650 or 750 prior to updating the preview.

Similarly, if the user does not like the theme or template that was selected at block 540, the user could, with input field 660 or input field 760, cause the theme to be changed. In some cases, the input field 660 or input field 760 may be a drop down list. In some cases, the dropdown list may provide a list that is ordered based on the similarity from the first domain to the template or theme listed. Thus, for example, the next theme in the drop down list may be the second closest based on the ranking or evaluation of the first domain against the plurality of themes at the second domain. However, in other cases, the list may be ordered based on alphabetical ordering, or other types of ordering.

Further, a user may change the input at any of blocks 620, 640, 642, 720, 740, and/or 742, and upon detecting that a change has been made or that the preview button has been pushed, the application may regenerate the preview.

In this way, the user could adjust various parameters to determine what a website on the SaaS platform's domain would look like without having to commit to signing up at the second domain.

In an optional embodiment, once the user is satisfied, a storefront may be created based on the preview. This is shown with block 560 in the embodiment of FIG. 5, and may be started by pressing button 670 in FIG. 6 or button 770 in FIG. 7.

In this case, the user may need to provide certain information to complete the creation of the second domain. As will be appreciated, in some cases the second domain may be a storefront and have potentially the same URL as the first domain, but hosted by a different provider, and thus while the term “second domain” is used herein, in some cases it may have the same location as the first domain.

In some cases, the generation at block 560 may create placeholders for products or services in such second domain.

In some cases, the migration may include merely incorporating the styling elements from the first domain to the second domain. In this case, substantive elements such as products may need to be subsequently added.

In some cases, the migration may be a structured migration in which missing information from the preview can be asked in a sequential or condensed order to the user to fill in such missing information. For example, product databases of products being sold at the second domain may need other information and the system could query the user for such other information in a manner that allows the information to be input in a straightforward manner.

In some cases, the migration may include both style elements as well as substantive elements from the previous domain. Thus, the migration may take products or services from the previous domain in some cases. In other case, other details from the first domain may be migrated to the second domain.

Therefore, the completion of the migration at block 560 could include creating the second domain with the style elements from the first domain, and in some cases could include other elements such as products or services in the second domain.

In some cases, the storefront may be populated with applications based on a region of the user, types of products being sold, among other options. The country or region selected with input fields 644 and 744 may also change shipping options, languages, among other differences for the preview and/or new domain.

From block 560 the process proceeds to block 570 and ends.

The above therefore provides a user experience system for providing content from a first domain as input to a service for generating an online store.

The above-discussed methods are computer-implemented methods and require a computer for their implementation/use. Such computer system could be implemented on any type of, or combination of, network elements or computing devices, and may for example use the computing device of FIG. 2.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer method comprising:
fetching, from a first address, first domain content;
analysing the first domain content to determine character information and content information;
selecting a template from amongst a plurality of templates associated with a Software-as-a-Service (SaaS) application based on at least one of the character information and the content information; and
configuring the SaaS application based on the character information and content information using the selected template.

2. The method of claim 1, wherein the selected template is a closest match to the content information amongst the plurality of templates.

3. The method of claim 1, wherein configuring the SaaS application based on the character information and content information using the selected template includes:
generating a website based on the selected template using the character information and content information.

4. The method of claim 1, wherein selecting the template utilizes a Large Language Model (LLM).

5. The method of claim 3, wherein the generating is performed by providing the template, content information and character information to a Large Language Model.

6. The method of claim 1, wherein the analysing comprises using the first content with a Large Language Model to determine the character information and content information from the first domain content.

7. The method of claim 3, further comprising providing a preview of the website.

8. The method of claim 1, wherein the first address is a uniform resource locator for a first domain, and the first domain content comprises at least one of an electronic storefront, a blog, a landing screen, and a website.

9. The method of claim 1, wherein the character information includes at least one of a colour scheme, fonts, and a tone of text.

10. A computer system comprising:
a processor; and
a communications subsystem,
wherein the computer system is configured to:
fetch, from a first address, first domain content;
analyse the first domain content to determine character information and content information;
select a template from amongst a plurality of templates associated with a Software-as-a-Service (SaaS) application based on at least one of the character information and the content information; and
configure the SaaS application based on the character information and content information using the selected template.

11. The computer system of claim 10, wherein the selected template is a closest match to the content information amongst the plurality of templates.

12. The computer system of claim 10, wherein the SaaS application is configured based on the character information and content information using the selected template by generating a website based on the selected template using the character information and content information.

13. The computer system of claim 10, wherein the computer system is configured to select the template utilizing a Large Language Model (LLM).

14. The computer system of claim 12, wherein the computer system is configured to generate by providing the template, content information and character information to a Large Language Model.

15. The computer system of claim 10, wherein the computer system is configured to analyse by using the first content with a Large Language Model to determine the character information and content information from the first domain content.

16. The computer system of claim 12, wherein the computer system is further configured to provide a preview of the website.

17. The computer system of claim 10, wherein the first address is a uniform resource locator for a first domain, and the first domain content comprises at least one of an electronic storefront, a blog, a landing screen, and a website.

18. The method of claim 10, wherein the character information includes at least one of a colour scheme, fonts, and a tone of text.

19. A non-transitory computer readable medium for storing instruction code, which, when executed by a processor within a computer system cause the computer system to:
fetch, from a first address, first domain content;
analyse the first domain content to determine character information and content information;
select a template from amongst a plurality of templates associated with a Software-as-a-Service (SaaS) application based on at least one of the character information and the content information; and
configure the SaaS application based on the character information and content information using the selected template.

20. The non-transitory computer readable medium of claim 19, wherein the selected template is a closest match to the content information amongst the plurality of templates.
